(19) United States
(12) Patent Application Publication
(10) Pub. No.: US 2023/0238693 A1
(43) Pub. Date: Jul. 27, 2023

(54) ANTENNA DEVICE

(71) Applicant: Fujitsu Limited, Kawasaki-shi (JP)

(72) Inventor: Hiroki Takahashi, Akishima (JP)

(73) Assignee: Fujitsu Limited, Kawasaki-shi (JP)

(21) Appl. No.: 17/971,713

(22) Filed: Oct. 24, 2022

(30) Foreign Application Priority Data
Jan. 21, 2022 (JP) 2022-008075

(51) Int. Cl. H01Q 1/48; H01Q 9/04

(52) U.S. Cl. CPC H01Q 1/48; H01Q 9/045

(57) ABSTRACT

An antenna device includes a ground plate, a first planar parasitic element provided, at a position overlapping the ground plate in a plan view, along the ground plate, the first planar parasitic element being provided away from the ground plate, a first ground element in a cylindrical shape, the first ground element including a first end connected to the ground plate and a second end connected to the first planar parasitic element, and a first monopole feeding element including a first feeding end and a first open end, the first feeding end being provided on a side of the ground plate and fed with power, and the first open end being provided in proximity to an edge of the first planar parasitic element.

### CROSS-REFERENCE TO RELATED APPLICATION

The present application is based upon and claims the benefit of priority from the prior Japanese Patent Application No. 2022-008075 filed on Jan. 21, 2022, with the Japanese Patent Office, the entire contents of which are incorporated herein by reference.

### FIELD

The present disclosure relates to an antenna device.

### BACKGROUND

There is a conventional planar antenna (antenna device) that includes a radiation element, a first ground conductor, a feeding line, a first dielectric substrate provided between the radiation element and the first ground conductor, a second dielectric substrate provided between the first ground conductor and the feeding line, and a feeding unit provided between the radiation element and the feeding line.

### SUMMARY

According to one aspect of an embodiment, an antenna device includes: a ground plate; a first planar parasitic element provided, at a position overlapping the ground plate in a plan view, along the ground plate, the first planar parasitic element being provided away from the ground plate; a first ground element in a cylindrical shape, the first ground element including a first end connected to the ground plate and a second end connected to the first planar parasitic element; and a first monopole feeding element including a first feeding end and a first open end, the first feeding end being provided on a side of the ground plate and fed with power, and the first open end being provided in proximity to an edge of the first planar parasitic element.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a perspective view of an antenna device 100 according to an embodiment.

FIG. 2A is a plan view illustrating the antenna device 100.

FIG. 2B is a side view illustrating the antenna device 100.

FIG. 3A is an equalization circuit of an antenna device 100.

FIG. 3B is a frequency characteristic of S11 parameter representing a reflection loss of the antenna device 100.

FIG. 4 is a drawing illustrating an antenna device 100A according to a first modified embodiment of the embodiment.

FIG. 5 is a drawing illustrating an antenna device 100B according to a second modified embodiment of the embodiment.

FIG. 6 is a drawing illustrating an antenna device 100C according to a third modified embodiment of the embodiment.

FIG. 7A is a plan view illustrating the antenna device 100C.

FIG. 7B is a side view illustrating the antenna device 100C.

FIG. 8 is a drawing illustrating an antenna device 100D according to a fourth modified embodiment of the embodiment.

FIG. 9 is a drawing illustrating an antenna device 100E according to a fifth modified embodiment of the embodiment.

FIG. 10A is a drawing illustrating an antenna device 100F1 according to a sixth modified embodiment of the embodiment.

FIG. 10B is a drawing illustrating an antenna device 100F2 according to the sixth modified embodiment of the embodiment.

FIG. 11A is a drawing illustrating an antenna device 100F3 according to the sixth modified embodiment of the embodiment.

FIG. 11B is a drawing illustrating an antenna device 100F4 according to the sixth modified embodiment of the embodiment.

### DESCRIPTION OF EMBODIMENT

There is a conventional planar antenna (antenna device) that includes a radiation element, a first ground conductor, a feeding line, a first dielectric substrate provided between the radiation element and the first ground conductor, a second dielectric substrate provided between the first ground conductor and the feeding line, and a feeding unit provided between the radiation element and the feeding line. The conventional antenna device adopts a direct feeding system in which power is directly fed such that the feeding line is connected to the radiation element (for example, see Japanese Laid-Open Patent Publication No. 2001-028511).

It is known that the bandwidth of the antenna device depends on the feeding system. An electromagnetic coupling feeding system in which the feeding line is electromagnetically coupled without being connected to the radiation element and the feeding line feeds power to the radiation element via the electromagnetic coupling provides a wider bandwidth than a direct coupling feeding system in which the feeding line is connected to the radiation element and directly feeds power.

In order to achieve a wider bandwidth in an antenna device, the electromagnetic coupling feeding system is more advantageous than the direct feeding system.

Therefore, it is desired to provide an antenna device capable of achieving a wider bandwidth by using the electromagnetic coupling feeding system.

Hereinafter, embodiments of antenna devices according to the present disclosure will be described.

### Embodiments

Hereinafter, an XYZ coordinate system will be defined and described. For the sake of convenience of explanation, −Z side is referred to as a lower side or downward, and +Z side is referred to as an upper side or upward, but they do not represent a universal vertical relationship. Furthermore, seeing the XY plane from +Z side is referred to as a plan view.

### Antenna Device 100

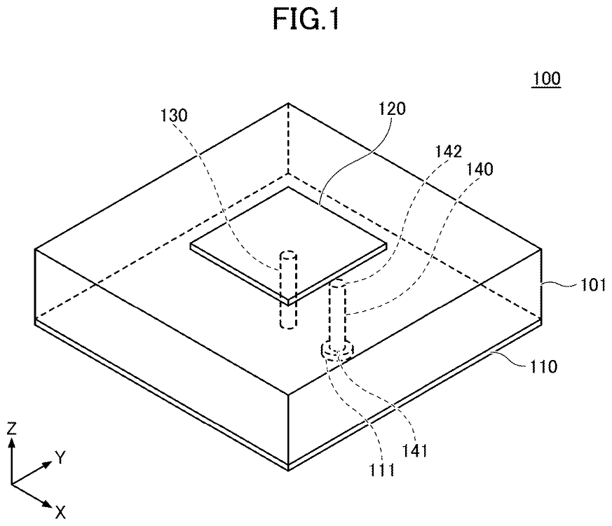

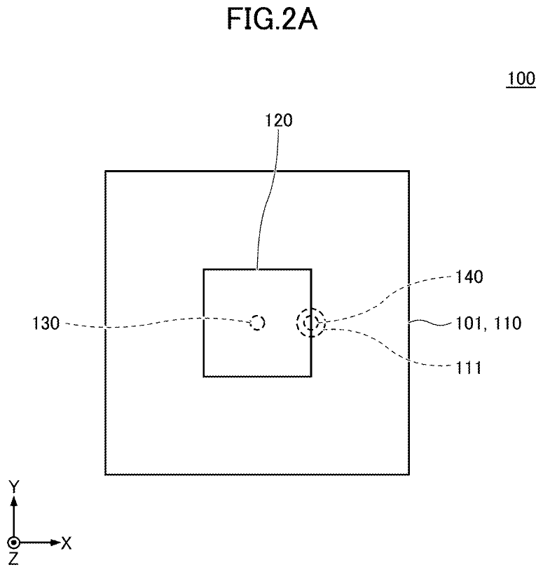

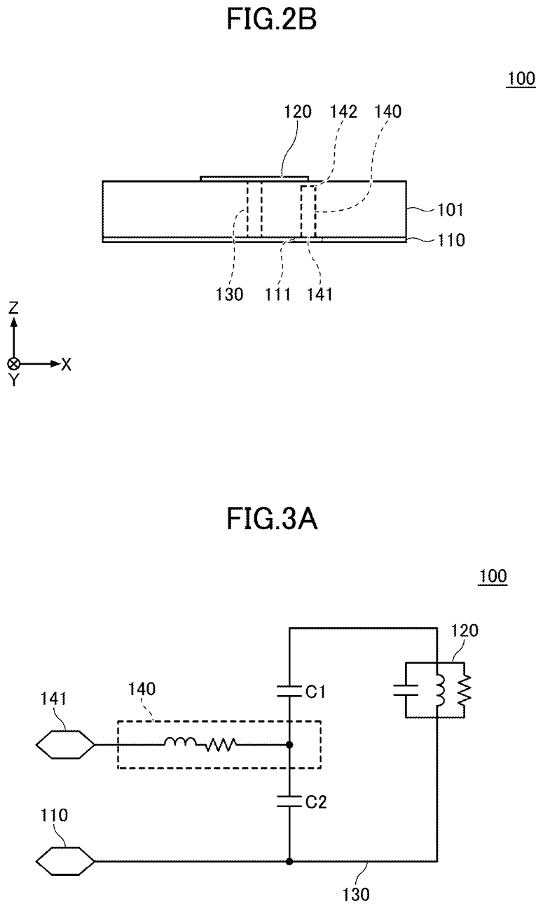

FIG. 1 is a perspective view illustrating an antenna device 100 according to an embodiment. FIG. 2A is a plan view illustrating the antenna device 100, and FIG. 2B is a side view illustrating the antenna device 100. The antenna device 100 is suitable for radiating, for example, radio waves in the millimeter-wave band or quasi-millimeter-wave band of the fifth-generation mobile communication system (5G) or the like, or radio waves in the frequency band radio waves of Sub-6.

The antenna device 100 includes a substrate 101, a ground plate 110, a planar parasitic element 120, a ground element 130, and a monopole feeding element 140. The substrate 101 is an example of a first dielectric, and the planar parasitic element 120 is an example of a first planar parasitic element. The ground element 130 is an example of a first ground element, and the monopole feeding element 140 is an example of a first monopole feeding element. The lower side of the planar parasitic element 120 is an example of a first side, and the upper side of the planar parasitic element 120 is an example of a second side.

In the antenna device 100, the planar parasitic element 120 functions as a radiation element, the ground element 130 functions as an enhancement element for correcting the current distribution, and the monopole feeding element 140 functions as a feeding element.

The substrate 101 is a dielectric substrate and has a constant thickness in the Z direction. The lower surface of the substrate 101 is an example of a first surface, and the upper surface is an example of a second surface. The lower surface of the substrate 101 is in contact with the upper surface of the ground plate 110, and the upper surface of the substrate 101 is in contact with the lower surface of the planar parasitic element 120. The substrate 101 maybe, for example, an insulating layer included in the wiring substrate, and is made of a resin-based organic material or a ceramic-based inorganic material. For example, the substrate 101 has a square shape in a plan view. In a plan view, two of the four outer edges of the substrate 101 are parallel to the X direction, and the remaining two are parallel to the Y direction.

The substrate 101 is not limited to a square shape in a plan view, and may have any shape as long as it has a plane in which the ground plate 110 is provided, and may be, for example, a part of a housing of an electronic apparatus that contains the antenna device 100. If the substrate 101 is not required, the antenna device 100 may be configured to not include the substrate 101. For example, such a configuration may be employed when the antenna device 100 radiates the radio waves of Sub-6.

The substrate 101 includes: a through hole through which the ground element 130 is inserted; and a hole portion through which the monopole feeding element 140 is inserted from the lower end side. The through hole through which the ground element 130 is inserted penetrates the substrate 101 in the Z direction, and the ground element 130 is filled from the lower end to the upper end of the inside of the through hole. Therefore, the shape of the through hole of the substrate 101 is equal to the shape of the ground element 130.

The hole portion in which the monopole feeding element 140 is inserted from the lower end side is formed in +Z direction from the lower surface of the substrate 101 and extends to immediately before the upper surface of the substrate 101. The monopole feeding element 140 is filled from the lower end to the upper end in the hole portion. Therefore, the shape of the hole portion of the substrate 101 is equal to the shape of the monopole feeding element 140. Instead of the hole portion in which the monopole feeding element 140 is inserted from the lower surface side, a through hole penetrating the substrate 101 in the Z direction may be formed, and the monopole feeding element 140 may be formed from the lower end of the through hole to immediately before the upper end.

The ground plate 110 is provided on the entire lower surface of the substrate 101 and is a metal foil (a metal plate) held at a ground potential. As the metal foil, for example, a metal foil such as copper, silver, tungsten alloy, molybdenum alloy, or the like can be used.

The ground plate 110 is parallel to the XY plane. The ground plate 110 is provided at a position where it overlaps the planar parasitic element 120, the ground element 130, and the monopole feeding element 140 in a plan view. The ground plate 110 functions as a ground plate for the planar parasitic element 120 serving as a radiation element and the monopole feeding element 140, and also functions as a reflector for reflecting, in +Z direction, a component of radio waves radiated in −Z direction by the planar parasitic element 120 and the monopole feeding element 140.

The lower end of the ground element 130 is connected to the center of the upper surface of the ground plate 110. The ground plate 110 has an opening 111 on +X side with respect to the center in a plan view. The opening 111 is provided to allow a feeding end 141 at the lower end of the monopole feeding element 140 to be arranged.

For example, the ground plate 110 has a square shape in a plan view, but is not limited to the square shape. The ground plate 110 may be disposed at a position where it overlaps the planar parasitic element 120, the ground element 130, and the monopole feeding element 140 in a plan view, and may be, for example, a metal layer having a ground potential possessed by an electronic apparatus that contains the antenna device 100.

The planar parasitic element 120 is a metal foil (a metal plate) provided in the center of the upper surface of the substrate 101. The metal foil may be made of, for example, a metal foil of copper, silver, tungsten alloy, or molybdenum alloy. The planar parasitic element 120 has a square shape in a plan view. Two of the four outer edges of the planar parasitic element 120 are parallel to the X direction, and the remaining two are parallel to the Y direction. The planar parasitic element 120 is disposed along the ground plate 110 parallel to the XY plane at a position where it overlaps the ground plate 110 in a plan view, and is separated from the ground plate 110. The center of the planar parasitic element 120 in a plan view coincides with the center of the ground plate 110 in a plan view.

The planar parasitic element 120 is capacitively coupled to the monopole feeding element 140 on the side of the edge on +X side that extends in the Y direction, and is parasitic on the monopole feeding element 140. The center of the lower surface of the planar parasitic element 120 is connected to the ground element 130. Since the ground element 130 is connected to the ground plate 110, the planar parasitic element 120 is connected to the ground plate 110 via the ground element 130.

By coupling the planar parasitic element 120 with the monopole feeding element 140, the input impedance of the planar parasitic element 120 as viewed from the feeding end 141 of the monopole feeding element 140 can resonate at not only a first resonance frequency 1 but also a second resonance frequency f2. In this configuration, the resonance frequency of the planar parasitic element 120 has not only the first resonance frequency f1 but also the second resonance frequency f2.

Therefore, the planar parasitic element 120 is fed through the monopole feeding element 140, resonates at the first resonance frequency f1 and the second resonance frequency f2, and radiates radio waves in +Z direction. The second resonance frequency f2 is, for example, a frequency included in the frequency band of 5G. Radio waves emitted in −Z direction by the planar parasitic element 120 are reflected by the ground plate 110 and propagate in +Z direction. Therefore, the planar parasitic element 120 is hereinafter described as radiating radio waves in +Z direction.

The length of one edge of the planar parasitic element 120 corresponds to ½ of the electric length of the wavelength of the planar parasitic element 120 at the second resonance frequency f2. The length corresponding to ½ of the electric length of the wavelength at the second resonance frequency f2 is not strictly limited to ½ of the electric length of the wavelength at the second resonance frequency f2, but includes a length that is slightly shorter than ½ of the electric length of the wavelength at the second resonance frequency f2 for adjustment for making the planar parasitic element 120 function as a resonance element resonating at the second resonance frequency f2. The second resonance frequency f2 can be adjusted by adjusting the length of one edge of the planar parasitic element 120 in the design stage.

The ground element 130 is provided inside the through hole provided at the center of the substrate 101 in a plan view, and is a cylindrical element having a lower end connected to the center of the upper surface of the ground plate 110 and an upper end connected to the center of the lower surface of the planar parasitic element 120. The lower end of the ground element 130 is an example of a first end, and the upper end of the ground element 130 is an example of a second end.

Since the ground element 130 extends in parallel to the Z direction, it is disposed perpendicular to the ground plate 110 and the planar parasitic element 120. The ground element 130 is made of metal. For example, the ground element 130 can be achieved as a via formed inside the through hole of the substrate 101 by plating treatment or with a metal filler.

Since a current distribution is generated between the planar parasitic element 120 and the ground plate 110, the current distribution between the planar parasitic element 120 and the ground plate 110 can be corrected to obtain a good current distribution by providing the ground element 130 having the upper end connected to the center of the lower surface of the planar parasitic element 120 and the lower end connected to the center of the upper surface of the ground plate 110. Furthermore, the effect of stabilizing the antenna at high frequencies and improving the antenna characteristics in general can be obtained by correcting the current distribution.

The monopole feeding element 140 is a cylindrical element (an I-shaped element) provided inside a hole portion provided on +X side with respect to the center of the substrate 101 in a plan view. The monopole feeding element 140 is a feeding element which resonates at the first resonance frequency f1. The first resonance frequency f1 is, for example, a frequency included in the frequency band of 5G. The first resonance frequency f1 can be adjusted by adjusting the length of the monopole feeding element 140 in the design stage. Since there is no restriction on the relationship between the length of the monopole feeding element 140 and the length of one edge of the planar parasitic element 120, the first resonance frequency f1 and the second resonance frequency f2 can be adjusted independently of each other.

The monopole feeding element 140 is made of metal. The monopole feeding element 140 can be achieved as a via formed inside the through hole of the substrate 101 by plating treatment or with a metal filler.

The monopole feeding element 140 includes: a feeding end 141 provided on the side of the ground plate 110 and fed with power; and an open end 142 provided in the vicinity of the edge of the planar parasitic element 120 on +X side that extends in the Y direction. The feeding end 141 is an example of a first feeding end, and the open end 142 is an example of a first open end. Since the monopole feeding element 140 extends parallel to the Z direction, the monopole feeding element 140 is arranged perpendicular to the ground plate 110 and the planar parasitic element 120.

The position of the center of the open end 142 in a plan view (the center of the monopole feeding element 140 in a plan view) coincides with the position at the center of the length, in the Y direction, of the edge on +X side of the planar parasitic element 120 that extends in the Y direction. Therefore, a half of the circular upper surface of the open end 142 of the planar parasitic element 120 overlaps the planar parasitic element 120 in a plan view. The position of the monopole feeding element 140 relative to the planar parasitic element 120 in a plan view may be a position where the distance between the center of the planar parasitic element 120 and the center of the monopole feeding element 140 is within a range of L/2±20%. L is a length of the edge of the planar parasitic element 120.

Further, due to the symmetry of the antenna device 100, the position of the center of the open end 142 in a plan view (the center of the monopole feeding element 140 in a plan view) may coincide with the position at the center of the length, in the Y direction, of the edge on −X side of the planar parasitic element 120 that extends in the Y direction.

The open end 142 is provided in the Z direction with a gap of 1/500 to 1/50 of the wavelength at the first resonance frequency from the lower surface of the planar parasitic element 120. As described above, the open end 142 is provided in the vicinity of the edge on +X side of the planar parasitic element 120 that extends in the Y direction, thereby achieving capacitive coupling between the monopole feeding element 140 and the planar parasitic element 120. Since the distance between the open end 142 and the lower surface of the planar parasitic element 120 is very narrow as described above, the length of the monopole feeding element 140 in the Z direction and the thickness of the substrate 101 in the Z direction are substantially equal.

Furthermore, by capacitively coupling the monopole feeding element 140 and the planar parasitic element 120, the input impedance of the planar parasitic element 120 can resonate not only at the first resonance frequency f1 but also the second resonance frequency f2. The ratio of capacitive coupling between the monopole feeding element 140 and the planar parasitic element 120 can be set by the distance between the open end 142 and the lower surface of the planar parasitic element 120.

The feeding end 141 is provided inside the opening 111 in a plan view, and the monopole feeding element 140 is insulated from the ground plate 110. The feeding end 141 is connected to a signal transmission and reception unit (not illustrated), and receives power from the signal transmission/reception unit.

The length between the feeding end 141 and the open end 142 of the monopole feeding element 140 is equivalent to ¼ of the electric length of the wavelength of the monopole feeding element 140 at the first resonance frequency f1. The length corresponding to ¼ of the electric length of the wavelength at the first resonance frequency f1 is not strictly limited to ¼ of the electric length of the wavelength at the first resonance frequency f1, but includes a length that is slightly shorter than ¼ of the electric length of the wavelength at the first resonance frequency f1 for adjustment for making the monopole feeding element 140 function as a resonance element resonating at the first resonance frequency f1. The first resonance frequency f1 is different from the second resonance frequency f2.

The input impedance of the planar parasitic element 120 becomes a value at which it can resonate at both the first resonance frequency f1 and the second resonance frequency f2 by capacitively coupling the monopole feeding element 140 and the planar parasitic element 120, and therefore, when power is fed by the monopole feeding element 140, the planar parasitic element 120 resonates at both the first resonance frequency f1 and the second resonance frequency f2.

### Polarization Direction

When the X direction is defined as the horizontal direction and the Y direction is defined as the vertical direction, the planar parasitic element 120 fed by the monopole feeding element 140 is excited in the horizontal direction, and accordingly, the antenna device 100 is an antenna device which radiates radio waves of the horizontal polarization.

In general, the bandwidth of the antenna device depends on the feeding system, and a wider bandwidth can be obtained with the electromagnetic coupling feeding system in which the feeding line is electromagnetically coupled without being connected to the radiation element and the feeding line feeds power to the radiation element via the electromagnetic coupling than with a direct coupling feeding system in which the feeding line is connected to the radiation element and directly feeds power.

The antenna device 100 adopts the electromagnetic coupling feeding system because the planar parasitic element 120 is fed by the monopole feeding element 140. The bandwidth of the antenna device is generally given as follows,

Bandwidth BW=(S−1)/Q√S,

where Q denotes a quality factor and S denotes a standing wave ratio. Therefore, the bandwidth increases when the Q value is lowered.

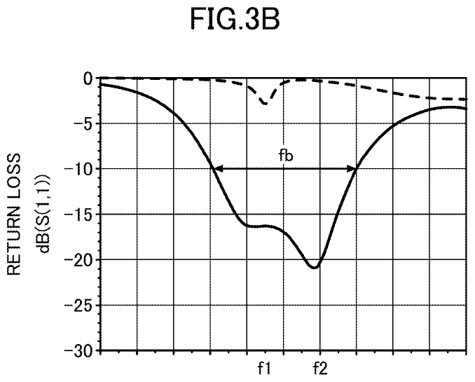

FIG. 3A is an equivalent circuit of the antenna device 100. In FIG. 3A, the ground plate 110 is indicated as a terminal, the planar parasitic element 120 is indicated as a parallel circuit of a resistor, an inductor, and a capacitor, and the monopole feeding element 140 is indicated as a series circuit of a resistor and an inductor. Since the resonance of the monopole feeding element 140 is much weaker than that of the planar parasitic element 120, the equivalent circuit of the monopole feeding element 140 does not include a capacitor. The capacitive coupling between the planar parasitic element 120 and the monopole feeding element 140 is represented by a capacitor C1, and the capacitance between: the ground plate 110 and the ground element 130; and the monopole feeding element 140 is represented by a capacitor C2.

In the antenna device 100, the open end 142 of the monopole feeding element 140 serving as the feeding element is positioned directly below the center of the length, in the Y direction, of the edge on +X side of the planar parasitic element 120 that extends in the Y direction. Since the monopole feeding element 140 is formed of vias or the like, the area of the upper surface of the open end 142 of the monopole feeding element 140 in a plan view is very small, and the area overlapping the planar parasitic element 120 is very small. For this reason, the open end 142 of the monopole feeding element 140 and the planar parasitic element 120 are coupled at one point of the equivalent capacitor C1.

For example, as a comparison, a case is hereinafter considered, in which, instead of the monopole feeding element 140, a monopole feeding element is used in which the open end 142 is bent in −X direction along the lower surface of the planar parasitic element 120 to form an L-shape. In this case, the area of the portion where the portion along the lower surface of the planar parasitic element 120 and the L-shaped monopole feeding element extend in parallel increases, and the amount of coupling between the planar parasitic element 120 and the L-shaped monopole feeding element increases. In this case, the equivalent circuit of the portion where the portion along the lower surface of the planar parasitic element 120 and the L-shaped monopole feeding element extend in parallel can be represented by dividing the extended portion. In other words, the divided parallel extended portion composed of an infinitesimal monopole element (a series circuit of an infinitesimal resistance component and an infinitesimal inductance component), the infinitesimal capacitance C, and the infinitesimal capacitance C2 can be represented as a circuit (a ladder circuit) connected in a ladder shape. Thus, the Q value of the antenna device is increases in accordance with an increase in the number of elements of the coupling equivalent circuit between the planar parasitic element 120 and the L-shaped monopole.

In contrast, in the antenna device 100, the open end 142 of the monopole feeding element 140 is located directly below the center of the length, in the Y direction, of the edge on +X side of the planar parasitic element 120 that extends in the Y direction, and the area where the upper surface of the open end 142 of the planar parasitic element 120 and the planar parasitic element 120 overlap in a plan view is very small. Therefore, the open end 142 and the planar parasitic element 120 are coupled at one point of a single capacitor C1, and as illustrated in FIG. 3A, there is only one series circuit of the capacitors C1 and C2, and the Q value becomes low. Since the Q value becomes low in this way, a wider bandwidth can be achieved.

The Q value of the antenna device 100 including the monopole feeding element 140 is about ½ of the Q value of the antenna device including the L-shaped monopole feeding element. Such a low Q value can be achieved by setting the distance between the center of the planar parasitic element 120 and the center of the monopole feeding element 140 within the range of L/2±20%, and setting the distance between the open end 142 and the lower surface of the planar parasitic element 120 to 1/500 to 1/50 of the wavelength at the first resonance frequency.

FIG. 3B is a frequency characteristic of the S11 parameter representing the reflection loss of the antenna device 100. The frequency characteristic of the S11 parameter of the antenna device 100 indicated by a solid line is obtained by electromagnetic field simulation, and represents the ratio of the reflected power to the input power at the feed terminal.

In FIG. 3B, the frequency of the S11 parameter of a reference antenna device in which the planar parasitic element 120 is omitted from the antenna device 100 for comparison is indicated by a broken line. The frequency characteristic of the S11 parameter of the reference antenna device can be understood as the frequency characteristic of the S11 parameter of only the monopole feeding element 140 and the ground element 130.

As illustrated by the characteristics of the solid line, for example, at a level where the parameter S11 is −10 dB, the frequency band fb from a frequency lower than the first resonance frequency f1 to a frequency higher than the second resonance frequency f2 is −10 dB or less. The frequency band fb is a frequency band including both a frequency band including the first resonance frequency f1 and a frequency band including the second resonance frequency f2. As described above, it is confirmed that the antenna device 100 achieves the S11 parameter of −10 dB or less in the frequency band fb including both the first resonance frequency f1 and the second resonance frequency f2, and that the antenna device 100 achieves a wider bandwidth.

Furthermore, as illustrated by a broken line in FIG. 3B, the frequency characteristic of the S11 parameter of only the monopole feeding element 140 is at a local minimum value at the first resonance frequency f1, which is about −3 dB, and the value of the S11 parameter is relatively large. As described above, the resonance of only the monopole feeding element 140 is very weak, and it has been found that by coupling with the planar parasitic element 120, a good frequency characteristic can be achieved in the S11 parameter with a wider bandwidth and low reflection loss as indicated by the solid line. This is because the monopole feeding element 140 and the planar parasitic element 120 are capacitively coupled so that the planar parasitic element 120 has an input impedance capable of resonating at the first resonance frequency f1 and the second resonance frequency f2.

As described above, the antenna device 100 includes the ground plate 110, the planar parasitic element 120, the first ground element 130 in a cylindrical shape having the lower end connected to the ground plate 110 and the upper end connected to the planar parasitic element 120, and the monopole feeding element 140 having the feeding end 141 and the open end 142, so that a wider bandwidth can be achieved.

Therefore, the antenna device 100 capable of achieving a wider bandwidth can be provided by using the electromagnetic coupling feeding system.

With the configuration in which the overlapping area of the open end 142 and the planar parasitic element 120 is reduced so that the open end 142 of the monopole feeding element 140 and the planar parasitic element 120 are coupled at one point of the single equivalent capacitor C1, the low Q value is attained, and accordingly, a wider bandwidth can be achieved.

Furthermore, since the planar parasitic element 120 and the ground plate 110 are connected by the ground element 130 at the center of the planar parasitic element 120, the current distribution of the planar parasitic element 120 is corrected and made into a preferable current distribution, and the low Q value and the wider bandwidth can be achieved more reliably.

Since the length between the feeding end 141 and the open end 142 corresponds to ¼ of the electric length of the wavelength of the monopole feeding element 140 at the first resonance frequency f1, the input impedance of the planar parasitic element 120 can resonate not only at the first resonance frequency f1 but also at the second resonance frequency f2. Therefore, the antenna device 100 capable of achieving a wider bandwidth including the frequency band of the first resonance frequency f1 and the frequency band of the second resonance frequency f2 can be provided by using the electromagnetic coupling feeding system.

Furthermore, since the planar parasitic element 120 has a square shape in a plan view and the length of one edge of the planar parasitic element 120 is equal to ½ of the electric length of the wavelength of the planar parasitic element 120 at the second resonance frequency f2, the planar parasitic element 120 resonates at the second resonance frequency f2, and a wider bandwidth can be achieved even in the frequency band including the second resonance frequency f2.

The ground element 130 is positioned at the center of the planar parasitic element 120 in a plan view, and the monopole feeding element 140 is positioned at the center of one of the four edges of the planar parasitic element 120 in a plan view. Therefore, the current distribution of the planar parasitic element 120 can be corrected by the ground element 130, and the coupling of the monopole feeding element 140 and the planar parasitic element 120 can be achieved at one point, so that the Q value can be lowered and a wider bandwidth can be achieved.

The distance between the open end 142 and the planar parasitic element 120 in the extending direction of the monopole feeding element 140 is 1/500 to 1/50 of the wavelength at the first resonance frequency f1. To provide the antenna device 100 capable of reliably achieving capacitive coupling between the open end 142 and the planar parasitic element 120, and capable of feeding power to the planar parasitic element 120 by the monopole feeding element 140. Furthermore, a ratio of the frequency band of the first resonance frequency f1 and the frequency band of the second resonance frequency f2 to the entirety can be set as illustrated in FIG. 3B by setting the ratio of capacitive coupling between the monopole feeding element 140 and the planar parasitic element 120 according to the distance between the open end 142 and the lower surface of the planar parasitic element 120.

Furthermore, the substrate 101 includes: the first surface (the lower surface) in contact with the surface of the ground plate 110; and the second surface (the upper surface) in contact with the surface of the planar parasitic element 120 on the side of the ground plate 110. Therefore, the ground plate 110 and the planar parasitic element 120 can be stably held, and by stabilizing the current distribution of the planar parasitic element 120, the antenna device 100 capable of achieving a wider bandwidth can be provided by using the electromagnetic coupling feeding system.

Since the ground element 130 is disposed perpendicular to the ground plate 110 and the planar parasitic element 120, the antenna device 100 capable of achieving a wider bandwidth by using the electromagnetic coupling feeding system can be provided by stabilizing the current distribution of the planar parasitic element 120.

Furthermore, since the monopole feeding element 140 is provided perpendicular to the ground plate 110 and the planar parasitic element 120, the stable electromagnetic coupling feeding system can be formed, and the antenna device 100 capable of achieving a wider bandwidth can be provided.

In the above description, a configuration in which the polarization direction of the antenna device 100 is horizontal has been explained. However, when the position of the center of the monopole feeding element 140 in a plan view is made to coincide with the position at the center of the length, in the X direction, of the edge on +Y side or −Y side of the planar parasitic element 120 that extends in the X direction, the antenna device 100 radiating radio waves of the vertical polarization can be achieved.

In the above description, a configuration in which the planar parasitic element 120 and the ground plate 110 are connected by the ground element 130 at the center of the planar parasitic element 120 has been explained. However, the position of the ground element 130 may be shifted from the center of the planar parasitic element 120 as long as the current distribution of the planar parasitic element 120 is not adversely affected.

In the above description, a configuration in which the antenna device 100 includes the substrate 101 has been explained. However, the substrate 101 does not have to be provided between the ground plate 110 and the planar parasitic element 120. For example, the ground plate 110 and the planar parasitic element 120 may be provided on inner walls of a housing or the like to be opposed to each other.

### First Modified Embodiment

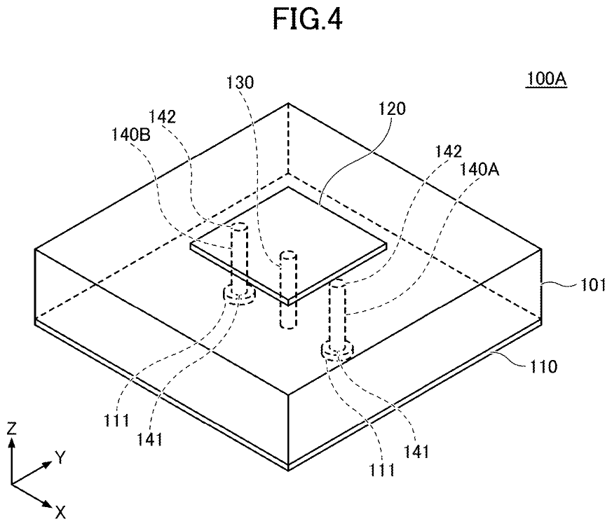

FIG. 4 is a drawing illustrating an antenna device 100A according to a first modified embodiment of the embodiment. The antenna device 100A has a configuration in which a monopole feeding element 140B is added to the antenna device 100 illustrated in FIGS. 1, 2A, and 2B. The monopole feeding element 140B is an example of a second monopole feeding element.

The monopole feeding element 140A of the antenna device 100A is the same as the monopole feeding element 140 of the antenna device 100 illustrated in FIGS. 1, 2A, and 2B. The configuration other than the above is the same as the configuration of the antenna device 100. For this reason, components that are substantially the same as the components of the antenna device 100 are denoted with the same reference numerals, and description thereabout is omitted.

The monopole feeding element 140B has a feeding end 141 and an open end 142 similarly to the monopole feeding element 140A. The feeding end 141 and the open end 142 of the monopole feeding element 140B are examples of a first feeding end and a second open end, respectively. The position of the center of the open end 142 of the monopole feeding element 140B in a plan view (the center of the monopole feeding element 140B in a plan view) coincides with the position at the center of the length, in the Y direction, of the edge on −X side of the planar parasitic element 120 that extends in the Y direction.

The position of the monopole feeding element 140B in a plan view is a position obtained by rotating, 180 degrees about the center of the planar parasitic element 120, the position of the monopole feeding element 140A relative to the center of the planar parasitic element 120 in a plan view. In other words, the position of the monopole feeding element 140B in a plan view is the position of the center of the length of the edge opposite to the edge where the monopole feeding element 140A is provided, among the four edges of the planar parasitic element 120 in a plan view.

In order to provide the monopole feeding element 140B, the substrate 101 may be provided with a second through hole corresponding to the monopole feeding element 140B, and the ground plate 110 may be provided with a second opening 111 corresponding to the monopole feeding element 140B.

In the antenna device 100A, radio waves different having phases shifted 180 degrees from each other are input into the feeding ends 141 of the monopole feeding elements 140A and 140B. The length of the planar parasitic element 120 in the X direction is equal to ½ of the electric length of the wavelength at the second resonance frequency f2, and the planar parasitic element 120 can resonate at both the first resonance frequency f1 and the second resonance frequency f2. Therefore, by inputting the first resonance frequency f1 of which the phase differs by 180 degrees, the planar parasitic element 120 to which power is fed by the monopole feeding elements 140A and 140B radiates radio waves in the horizontal direction.

As described above, in the antenna device 100A, radio waves having phases shifted 180 degrees from each other are input to the feeding ends 141 of the monopole feeding elements 140A and 140B, so that the antenna device 100A can achieve a higher accuracy in the polarization direction with respect to the horizontal direction and can achieve a wider bandwidth by using the electromagnetic coupling feeding system.

If the center of the monopole feeding elements 140A and 140B in a plan view coincides with the center of the length of the end edge extending in the X direction on +Y side and −Y side of the planar parasitic element 120 in the X direction, the antenna device 100A that radiates vertically polarized radio waves can be achieved.

### Second Modified Embodiment

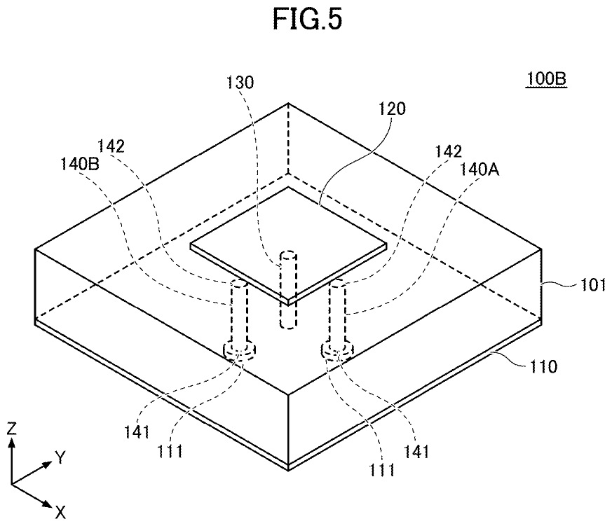

FIG. 5 is a drawing illustrating an antenna device 100B according to a second modified embodiment of the embodiment. The antenna device 100B has a configuration in which the positions of the monopole feeding elements 140A and 140B of the antenna device 100A illustrated in FIG. 4 are changed to positions that enable both circularly polarization and dual polarization of horizontal polarization and vertical polarization. Since components other than the above are substantially the same as the components of the antenna device 100A, components that are substantially the same as the components of the antenna device 100A are denoted with the same reference numerals, and description thereabout is omitted.

The position of the center of the monopole feeding element 140B in a plan view coincides with the position at the center of the length, in the X direction, of the edge on −Y side of the planar parasitic element 120 that extends in the X direction. The position of the monopole feeding element 140B in a plan view is a position obtained by rotating, 90 degrees clockwise about the center of the planar parasitic element 120, the position of the monopole feeding element 140A about the center of the planar parasitic element 120 in a plan view. In other words, the position of the monopole feeding element 140B in a plan view is the position at the center of the length of an edge adjacent to the edge where the monopole feeding element 140A is provided, among the four edges of the planar parasitic element 120 in a plan view.

In order to obtain circular polarization, in the antenna device 100B, radio waves having phases shifted 90 degrees from each other are input to the feeding ends 141 of the monopole feeding elements 140A and 140B. By inputting to the monopole feeding element 140A radio waves of which the phases are advanced 90 degrees from the phase of the monopole feeding element 140B, the radio waves of the circular polarization in the counterclockwise direction in a plan view can be radiated. By providing to the monopole feeding element 140B radio waves of which the phases are advanced 90 degrees from the phase of the monopole feeding element 140A, the radio waves of the circular polarization in the clockwise direction in a plan view can be radiated.

The antenna device 100B can be provided that is capable of radiating circularly polarized radio waves with feeding of radio waves having phases shifted 90 degrees from each other to the feeding ends 141 of the monopole feeding elements 140A and 140B and can achieve a wider bandwidth by using the electromagnetic coupling feeding system.

The antenna device 100B may include two monopole feeding elements 140A and two monopole feeding elements 140B. The second monopole feeding element of the two monopole feeding element 140A may be disposed at the same position as the monopole feeding element 140B illustrated in FIG. 4. The position of the second monopole feeding element of the two monopole feeding element 140B may coincide with the position at the center of the length, in the X direction, of the edge on +Y side of the planar parasitic element 120 that extends in the X direction.

In this case, radio waves having phases shifted 180 degrees may be input to the two monopole feeding elements 140A, radio waves having phases shifted 180 degrees may be input to the two monopole feeding elements 140B, and radio waves having phases shifted 90 degrees may be input to the monopole feeding elements 140A and 140B so as to achieve circular polarization. In other words, radio waves different in phase by 90 degrees in a clockwise or counterclockwise direction in a plan view may be input to the four monopole feeding elements 140A and 140B in total. The antenna device 100B can be provided that is capable of achieving circular polarization with a higher accuracy and achieving a wider bandwidth by using the electromagnetic coupling feeding system. Furthermore, the total of 4 monopole feeding elements 140A and 140B can be divided into 2 groups each including one monopole feeding element 140A and one monopole feeding element 140B to achieve dual polarization of clockwise circular polarization or counterclockwise circular polarization.

Furthermore, in order to obtain dual polarization of horizontal polarization and vertical polarization, radio waves having the same phase are input to the feeding ends 141 of the monopole feeding elements 140A and 140B, so that the radio waves of the horizontal polarization can be radiated from the monopole feeding element 140A, and the radio waves of the vertical polarization can be radiated from the monopole feeding element 140B. In this case, baseband streams can be doubled, and the antenna device 100B capable of achieving a wider bandwidth by using the electromagnetic coupling feeding system and capable of communicating with a larger number of streams can be provided.

### Third Modified Embodiment

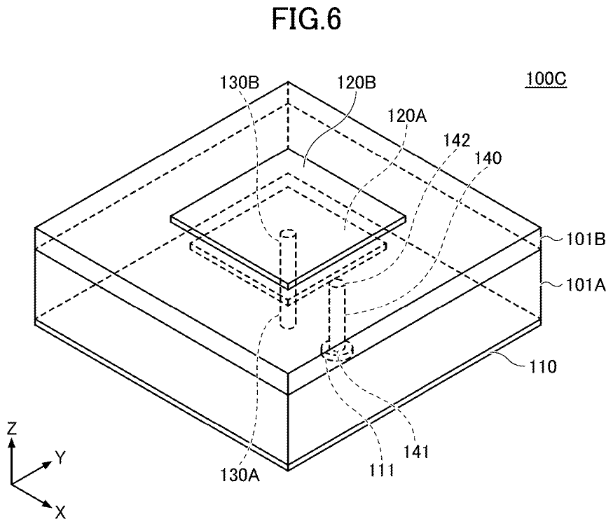

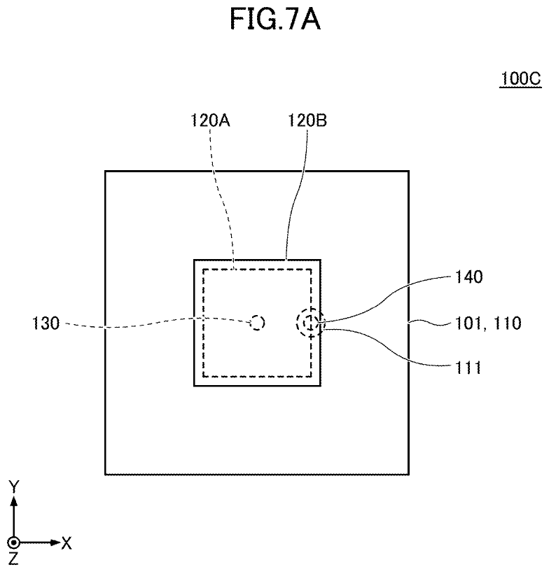

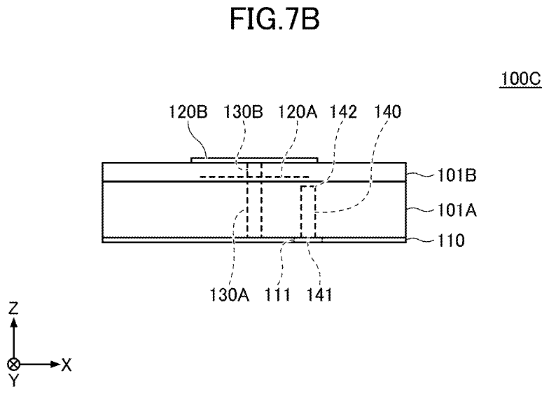

FIG. 6 is a drawing illustrating an antenna device 100C according to a third modified embodiment of the embodiment. FIG. 7A is a plan view illustrating the antenna device 100C. FIG. 7B is a side view illustrating the antenna device 100C.

The antenna device 100C has a configuration in which a substrate 101B, a planar parasitic element 120B, and a ground element 130B are added to the antenna device 100 illustrated in FIGS. 1, 2A, and 2B. The substrate 101B, the planar parasitic element 120B, and the ground element 130B are examples of a second dielectric, a second planar parasitic element, and a second ground element, respectively. The lower surface of the substrate 101B is an example of a third surface, and the upper surface of the substrate 101B is an example of a fourth surface.

The substrate 101A, the planar parasitic element 120A, and the ground element 130A are the same as the substrate 101, the planar parasitic element 120, and the ground element 130, respectively, illustrated in FIGS. 1, 2A, and 2B. Since components other than the above are substantially the same as the components of the antenna device 100A, components that are substantially the same as the components of the antenna device 100A are denoted with the same reference numerals, and description thereabout is omitted.

The substrate 101B is superposed on the substrate 101A and the planar parasitic element 120A. The size of the substrate 101B in a plan view is equal to the size of the substrate 101A in a plan view, and is provided in alignment with the substrate 101A. The substrate 101B has a through hole through which the ground element 130B is inserted. The substrate 101B, together with the substrate 101A, may be a part of the housing of the electronic apparatus containing the antenna device 100.

The planar parasitic element 120B is a metal foil (a metal plate) provided at the center of the upper surface of the substrate 101B. As the metal foil, for example, a metal foil such as copper, silver, tungsten alloy, molybdenum alloy, or the like can be used. For example, the planar parasitic element 120B has a square shape in a plan view and is larger than the size of the planar parasitic element 120A.

Two of the four outer edges of the planar parasitic element 120B are parallel to the X direction, and the remaining two are parallel to the Y direction. The planar parasitic element 120B is disposed on the planar parasitic element 120A via the substrate 101B at a position overlapping the ground plate 110 in a plan view. The center of the planar parasitic element 120B in a plan view coincides with the center of the planar parasitic element 120A in a plan view.

The planar parasitic element 120B is capacitively coupled to the planar parasitic element 120A. The planar parasitic element 120B is fed from the monopole feeding element 140 via the planar parasitic element 120A, resonates at a third resonance frequency f3, and radiates radio waves in +Z direction. The third resonance frequency f3 is, for example, a frequency included in the frequency band of 5G. The third resonance frequency f3 is different from the first resonance frequency f1 and the second resonance frequency f2.

In this case, for example, since the planar parasitic element 120B is larger than the size of the planar parasitic element 120A in a plan view, the third resonance frequency f3 is lower than the second resonance frequency f2. When the third resonance frequency f3 is to be set higher than the second resonance frequency f2, the antenna device 100C may be designed so that the planar parasitic element 120B is smaller than the planar parasitic element 120A in a plan view. Designing the planar parasitic element 120B to make it smaller than the planar parasitic element 120A in a plan view means making the length of one side of the planar parasitic element 120B be shorter than the length of one side of the planar parasitic element 120A.

The length of one side of the planar parasitic element 120B corresponds to ½ of the electric length of the wavelength at the third resonance frequency f3. The length corresponding to ½ of the electric length of the wavelength at the third resonance frequency f3 is not strictly limited to ½ of the electric length of the wavelength at the third resonance frequency f3, but includes a length that is slightly shorter than ½ of the electric length of the wavelength at the third resonance frequency f3 for adjustment for making the planar parasitic element 120B function as a resonance element resonating at the third resonance frequency f3.

The ground element 130B is provided in a through hole of the substrate 101B. Since the through hole of the substrate 101B is in communication with the through hole of the substrate 101A, the lower end of the ground element 130B is connected to the upper end of the ground element 130A. The ground element 130B is grounded via the ground element 130A.

Since the planar parasitic element 120B resonates at the third resonance frequency f3 and radiates radio waves in +Z direction, a wider bandwidth can be achieved than the antenna device 100 illustrated in FIGS. 1, 2A, and 2B.

Therefore, the antenna device 100C capable of having a wider bandwidth can be achieved by using the electromagnetic coupling feeding system. The antenna device 100C may not include the ground element 130B. In this case, the planar parasitic element 120B may parasitically coupled to the planar parasitic element 120A and be fed via the planar parasitic element 120A.

### Fourth Modified Embodiment

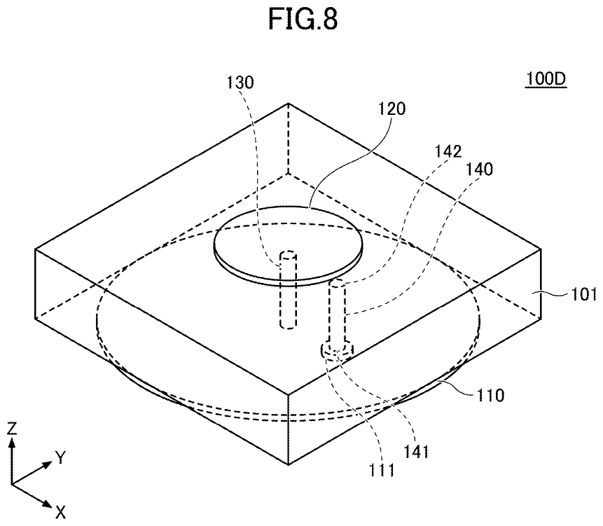

FIG. 8 is a drawing illustrating an antenna device 100D according to a fourth modified embodiment of the embodiment. The antenna device 100D has a configuration in which the ground plate 110 and the planar parasitic element 120 of the antenna device 100 illustrated in FIGS. 1, 2A, and 2B are formed into a circular shape. The diameter of the planar parasitic element 120 is a length corresponding to ½ of the electric length of the wavelength of the planar parasitic element 120 at the second resonance frequency f2. The planar parasitic element 120 in the circular shape is fed via the monopole feeding element 140, resonates at the second resonance frequency f2, and radiates radio waves in +Z direction.

As described above, the antenna device 100D including the planar parasitic element 120 in the circular shape can achieve a wider bandwidth by using the electromagnetic coupling feeding system, similarly to the antenna device 100 illustrated in FIG. 1, FIG. 2A, and FIG. 2B.

### Fifth Modified Embodiment

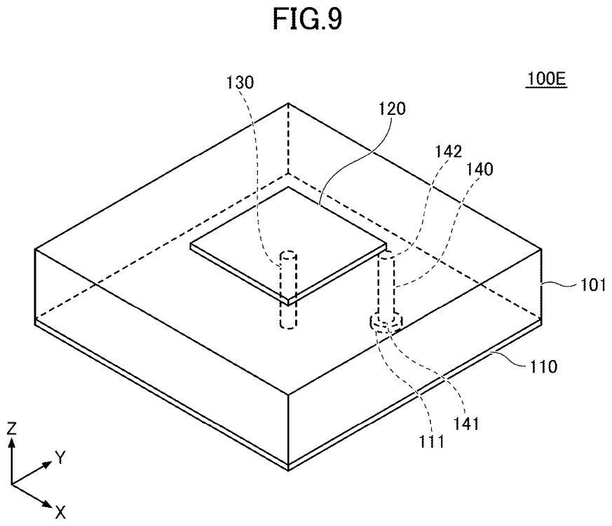

FIG. 9 is a drawing illustrating an antenna device 100E according to a fifth modified embodiment of the embodiment. The antenna device 100E is a modified embodiment of the antenna device 100 illustrated in FIGS. 1, 2A, and 2B for oblique polarization. In the antenna device 100E, the position of the monopole feeding element 140 is different from the position of the monopole feeding element 140 of the antenna device 100 illustrated in FIGS. 1, 2A, and 2B.

In the antenna device 100E, the position of the center of the open end 142 of the monopole feeding element 140 (the center of the monopole feeding element 140 in a plan view) coincides with the position of a corner (an apex) on +X side and +Y side of the planar parasitic element 120.

Thus, the center of the monopole feeding element 140 in a plan view coincides with the corner of the planar parasitic element 120, so that the oblique polarization can be achieved.

In orthogonal polarization multiplexing transmission using horizontal polarization and vertical polarization, the reflection characteristics of the ground, buildings, and the like differ depending on the polarization, and therefore, there may be a difference in the received signal power between the polarizations. However, if two monopole feeding elements 140 are arranged at two corners of the planar parasitic element 120, two oblique polarizations of +45° polarization and −45° polarization can be achieved. The two oblique polarizations of +45° polarization and −45° polarization, as well as the two circular polarizations of clockwise polarization and counterclockwise polarization, can equalize the received signal powers of the two systems. For example, by performing polarized MIMO transmission, the received signal powers of the two systems can be equalized.

Therefore, the antenna device 100 capable of achieving a wider bandwidth even in the frequency band of Sub-6 can be provided by using the electromagnetic coupling feeding system.

### Sixth Modified Embodiment

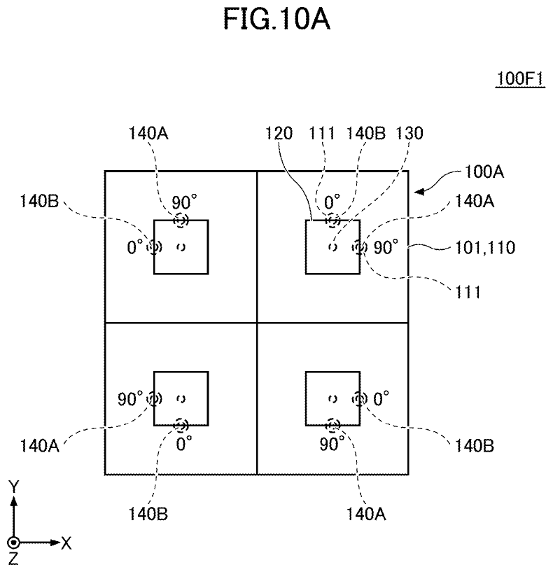

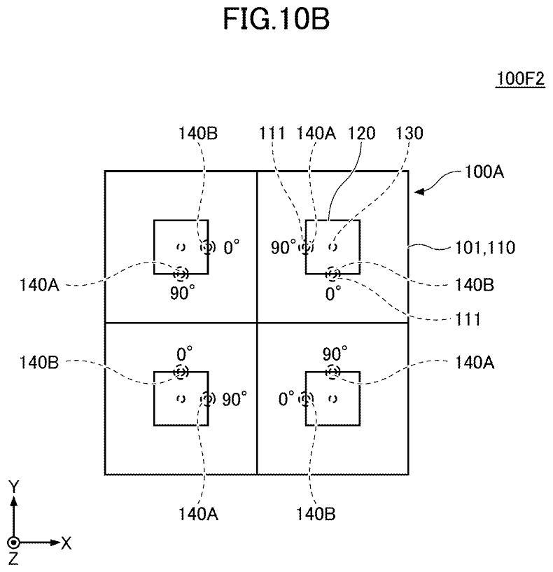

FIGS. 10A and 10B illustrate antenna devices 100F1 and 100F2, respectively, according to a sixth modified embodiment of the embodiment. The antenna device 100F1 illustrated in FIG. 10A includes four antenna devices 100A illustrated in FIG. 5 as an example. In FIG. 10A, the monopole feeding element 140A is situated on +X side or −X side of the ground element 130, and the monopole feeding element 140B is situated on +Y side or −Y side of the ground element 130.

In the four antenna devices 100A illustrated in FIG. 10A, clockwise circular polarization can be achieved with the four antenna devices 100A with feeding of radio waves having phases of 0° and 90° to the monopole feeding elements 140A and 140B as illustrated in FIG. 10A and feeding power to the planar parasitic element 120 via the monopole feeding elements 140A and 140B, and since the positions of the monopole feeding elements 140A and 140B of the four antenna devices 100A are shifted clockwise by 90° with respect to the center of the four antenna devices 100A, the axial ratio of circular polarization can be improved, and the clockwise and counterclockwise cross-polarization discrimination can be improved to achieve a wider bandwidth. The increase in the bandwidth is several times more effective than the case where only a single antenna device 100A is provided. The counterclockwise circular polarization can be achieved by switching the phases of 0° and 90° of the respective antenna devices 100A.

Even if the arrangement of the monopole feeding elements 140A and 140B in each of the antenna devices 100A illustrated in FIG. 10A is changed as illustrated in FIG. 10B, circularly polarized radio waves can be emitted in a similar manner.

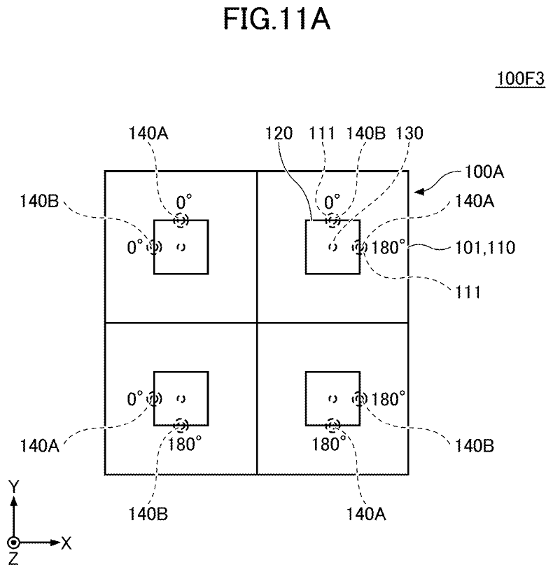

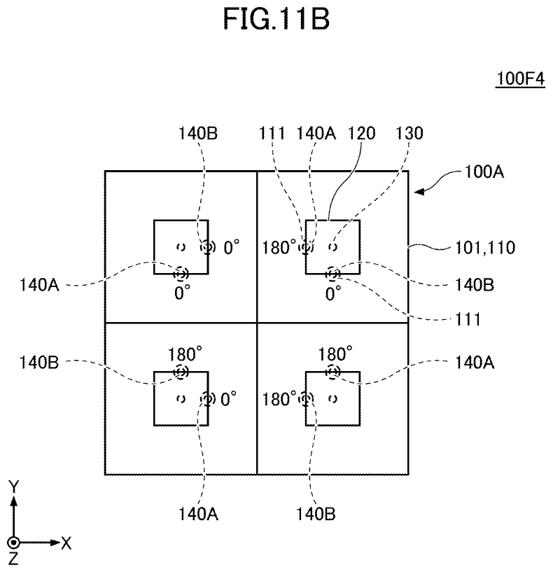

FIGS. 11A and 11B illustrate antenna devices 100F3 and 100F4, respectively, according to the sixth modified embodiment of the embodiment. The configurations of the antenna devices 100F3 and 100F4 are equal to the configurations of the antenna devices 100F1 and 100F2, respectively. The antenna devices 100F3 and 100F4 radiate radio waves by dual polarization of horizontal polarization and vertical polarization.

In an antenna device 100F3, the monopole feeding element 140A of the antenna device 100A on the upper left side and the monopole feeding element 140B of the antenna device 100A on the lower left side radiate radio waves having phases of 0° and 180°, and the monopole feeding element 140B of the antenna device 100A on the upper left side and the monopole feeding element 140A of the antenna device 100A on the upper right side radiate radio waves having phases of 0° and 180°. In this way, the monopole feeding elements 140A and 140B of the two antenna devices 100A adjacent to each other in the Y direction and the X direction are arranged symmetrically and emit radio waves differing in phase by 180°. This is also applicable to the antenna device 100F4 illustrated in FIG. 11B.

For example, the monopole feeding element 140A of the antenna device 100A on the upper left side and the monopole feeding element 140B of the antenna device 100A on the lower left side emit vertically polarized radio waves having phases of 0° and 180°, so that the cross-polarization components in the horizontal direction can be canceled. The monopole feeding element 140B of the antenna device 100A on the upper left side and the monopole feeding element 140A of the antenna device 100A on the upper right side emit radio waves in the horizontal direction having phases of 0° and 180°, thereby canceling the cross-polarization components in the vertical direction. This is also applicable to other elements.

Since the monopole feeding elements 140A and 140B having such a symmetrical arrangement emit radio waves having phases different by 180°, the axial ratio of the linearly polarized waves is improved, and the cross-polarization discrimination is improved, so that a wider bandwidth can be achieved. The increase in the bandwidth is several times more effective than the case where only a single antenna device 100A is provided.

The antenna device capable of achieving a wider bandwidth by using the electromagnetic coupling feeding system can be provided.

Although the antenna device according to the exemplary embodiment of the present disclosure has been described above, the present disclosure is not limited to the specifically disclosed embodiment, and various modifications and changes can be made without departing from the subject matter described in the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present inventions has been described in detail, it should be understood that the various changes, substitutions, and alterations could be made hereto without departing from the spirit and scope of the invention.

What is claimed is:

1. An antenna device comprising:
a ground plate;
a first planar parasitic element provided, at a position overlapping the ground plate in a plan view, along the ground plate, the first planar parasitic element being provided away from the ground plate;
a first ground element in a cylindrical shape, the first ground element including a first end connected to the ground plate and a second end connected to the first planar parasitic element; and
a first monopole feeding element including a first feeding end and a first open end, the first feeding end being provided on a side of the ground plate and fed with power, and the first open end being provided in proximity to an edge of the first planar parasitic element.

2. The antenna device according to claim 1, wherein a length between the first feeding end and the first open end is a length corresponding to ¼ of an electric length of a wavelength of the first monopole feeding element at a first resonance frequency.

3. The antenna device according to claim 2, wherein the first planar parasitic element has a square shape in the plan view, and a length of one edge of the first planar parasitic element is a length corresponding to ½ of an electric length of a wavelength of the first planar parasitic element at a second resonance frequency.

4. The antenna device according to claim 3, wherein the first ground element is situated at a center of the first planar parasitic element in the plan view, and the first monopole feeding element is situated at a center of a length of one edge of four edges of the first planar parasitic element in the plan view.

5. The antenna device according to claim 4, further comprising a second monopole feeding element including a second feeding end and a second open end, the second monopole feeding element being provided at a position at a center of a length of an edge adjacent to the one edge of the four edges of the first planar parasitic element in the plan view, or being provided at a position at a center of a length of an edge opposite to the one edge of the four edges of the first planar parasitic element in the plan view, the second feeding end being provided on the side of the ground plate and fed with power, and the second open end being provided in proximity to an edge of the first planar parasitic element.

6. The antenna device according to claim 2, wherein the first planar parasitic element has a circular shape in the plan view, and
a diameter of the first planar parasitic element is a length corresponding to ½ of an electric length of a wavelength of the first planar parasitic element at a second resonance frequency.

7. The antenna device according to claim 1, wherein the first ground element is situated at a center of the first planar parasitic element in the plan view, and
the antenna device further comprises:
a second monopole feeding element including a second feeding end and a second open end, the second monopole feeding element being situated at a position obtained by rotating, clockwise or counterclockwise 90 degrees or 180 degrees about the center of the first planar parasitic element, a position of the first monopole feeding element with reference to a position of the first planar parasitic element in the plan view, the second feeding end being provided on the side of the ground plate and fed with power, and the second open end being provided in proximity to an edge of the first planar parasitic element.

8. The antenna device according to according to claim 2, wherein a distance between the first open end and the first planar parasitic element in a direction in which the first monopole feeding element extends is 1/500 to 1/50 of a wavelength of the first resonance frequency.

9. The antenna device according to claim 1, further comprising:
a first dielectric including a first surface in contact with a surface of the ground plate and a second surface in contact with a surface of the first planar parasitic element on the side of the ground plate.

10. The antenna device according to claim 1, wherein the first ground element is disposed in a direction perpendicular to the ground plate and the first planar parasitic element.

11. The antenna device according to claim 10, wherein the first monopole feeding element is disposed in a direction perpendicular to the ground plate and the first planar parasitic element.

12. The antenna device according to claim 1, further comprising:
a second planar parasitic element provided, at a position overlapping the ground plate in the plan view, along the first planar parasitic element, the second planar parasitic element being provided on a second side opposite a first side from the first planar parasitic element, and the ground plate being situated on the first side; and
a second ground element connecting the first planar parasitic element and the second planar parasitic element, the second ground element being disposed on an extension line of the first ground element.

13. The antenna device according to claim 12, further comprising:
a second dielectric including a third surface and a fourth surface, the third surface being in contact with a surface of the first planar parasitic element on a side of the second planar parasitic element, and the fourth surface being in contact with a surface of the second planar parasitic element on a side of the first planar parasitic element.
